(19) United States
(12) Patent Application Publication
(10) Pub. No.: US 2024/0160697 A1
(43) Pub. Date: May 16, 2024

(54) INFORMATION PROCESSING DEVICE, INFORMATION PROCESSING METHOD, AND RECORDING MEDIUM IN WHICH INFORMATION PROCESSING PROGRAM IS RECORDED

(71) Applicant: TOYOTA JIDOSHA KABUSHIKI KAISHA, Toyota-shi (JP)

(72) Inventors: Masato HOZUMI, Mishima-shi (JP); Masao YANO, Sunto-gun (JP); Tetsuya SHOJI, Susono-shi (JP)

(73) Assignee: TOYOTA JIDOSHA KABUSHIKI KAISHA, Toyota-shi (JP)

(21) Appl. No.: 18/373,625

(22) Filed: Sep. 27, 2023

(30) Foreign Application Priority Data
Nov. 11, 2022 (JP) 2022-181341

(51) Int. Cl. G06F 18/2135

(52) U.S. Cl. CPC G06F 18/2135

(57) ABSTRACT

An information processing device, that acquires, from a plurality of user terminals, measurement data measured by a plurality of analytical method; quantifies the acquired measurement data using a predetermined statistical method; and displays, on a display of at least one user terminal of the plurality of user terminals, a necessary analytical method among the plurality of analytical method based on results of the quantification.

### CROSS-REFERENCE TO RELATED APPLICATION

This application is based on and claims priority under 35 USC 119 from Japanese Patent Application No. 2022-181341 filed on Nov. 11, 2022, the disclosure of which is incorporated by reference herein.

### BACKGROUND

### Technical Field

The present disclosure relates to an information processing device, an information processing method, and a recording medium in which an information processing program is recorded.

### Related Art

Japanese Patent Application Laid-open (JP-A) No. 2020-134156 discloses a measurement guide device including: a database that stores a virtual measured signal and a measurement procedure that are obtained by simulation; a similarity search section that extracts, from the database, a virtual measured signal group similar to measurement results obtained by a measurement device and a measurement procedure group regarding the virtual measured signals; and a next-point proposal section that selects at least one measurement procedure from the measurement procedure group obtained by the similarity search section and determines the next measurement point.

JP-A No. 2020-176951 discloses an electronic device that selects any of plural parameters generated by machine learning and uses the selected parameter to perform an analysis of spectral data representing spectral intensities of plural spectral components by receiving light reflected from a food product that is the subject of analysis. Specifically, the electronic device selects any of the plural parameters in accordance with at least any of the type of the subject of analysis, the required accuracy for the analysis, and processes performed after the analysis.

Although proposals have been made to propose measurement procedures and to select parameters during analysis, there has been nothing proposing an appropriate analytical method from among plural analytical methods.

### SUMMARY

An aspect of the present disclosure is an information processing device, that includes: a memory; and a processor coupled to the memory, the processor being configured to: acquire, from a plurality of user terminals, measurement data measured by a plurality of analytical method; quantify the acquired measurement data using a predetermined statistical method; and display, on a display of at least one user terminal of the plurality of user terminals, a necessary analytical method among the plurality of analytical method based on results of the quantification.

### BRIEF DESCRIPTION OF THE DRAWINGS

FIG. 1 is a diagram showing an example of the schematic configuration of an information processing system pertaining to embodiments of the present disclosure;

FIG. 2 is a block diagram showing an example of main configurations of electrical systems of a user terminal and a cloud server in the information processing system pertaining to the embodiments;

FIG. 3 is a drawing showing an example where features are found by performing a principal component analysis on microscopic images and X-ray diffractions;

FIG. 4 is a drawing for describing a heatmap created by a processing unit;

FIG. 5 is a flowchart showing an example of a flow of processes performed by the cloud server of the information processing system pertaining to a first embodiment;

FIG. 6 is a drawing for describing a heatmap including a performance value; and

FIG. 7 is a flowchart showing an example of a flow of processes performed by the cloud server of the information processing system pertaining to a second embodiment.

### DETAILED DESCRIPTION

Examples of embodiments of the present disclosure will be described in detail below with reference to the drawings. It will be noted that components and processes that do work having the same action or functions are assigned the same reference signs throughout the drawings, and redundant description thereof may be omitted as appropriate. Furthermore, the present disclosure is not in any way limited to the following embodiments and can be implemented with changes made thereto as appropriate within the scope of the object of the present disclosure.

### First Embodiment

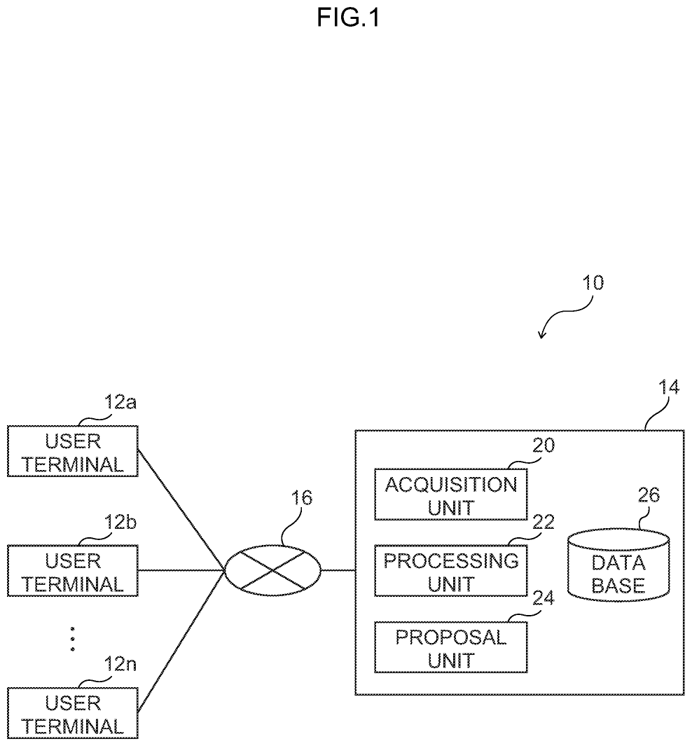

An information processing system 10 pertaining to a first embodiment will now be described. FIG. 1 is a diagram showing the schematic configuration of the information processing system 10 pertaining to the present embodiment.

The information processing system 10 includes plural user terminals 12a, 12b, . . . , 12n and a cloud server 14 that is an example of an information processing device. The plural user terminals 12a, 12b, . . . , 12n and the cloud server 14 are connected to each other via a network 16 such as, for example, a local area network (LAN) or the internet. It will be noted that, below, when referring to one user terminal, it will simply be called the user terminal 12.

Each of the user terminals 12a to 12n sends to the cloud server 14 material-related measurement data measured by plural analytical methods. Then, the cloud server 14 performs a process to quantify the measurement data using a predetermined statistical method and propose a necessary analytical method from among the plural analytical methods using the results of the quantification. Because of this, users become able to inhibit needless analyses.

Specifically, the plural user terminals 12a, 12b, . . . , 12n are operated by plural different users. Each user inputs, to the user terminal 12 that he/she operates, measurement data obtained by measuring a material sample the user wants to analyze. Then, the user operates the user terminal 12 to send the measurement data to the later-described cloud server 14. The user terminal 12 sends, via the network 16 to the cloud server 14, the measurement data that have been input by the user.

The cloud server 14 has an acquisition unit 20, a processing unit 22 serving as an example of a quantification unit, a proposal unit 24, and a database 26.

The acquisition unit 20 acquires, from each of the plural user terminals 12a to 12n, the material-related measurement data measured by the plural analytical methods and stores the measurement data in the database 26. Examples of the plural analytical methods include X-ray diffraction (XRD), small-angle X-ray scattering (SAXS), X-ray absorption fine structure (XAFS), microscopes, Raman spectroscopy, infrared spectroscopy (IR), nuclear magnetic resonance (NMR), and mass spectrometry (MS).

The processing unit 22 uses the measurement data stored in the database 26 to quantify the measurement data and selects a necessary analytical method from among the plural analytical methods using the results of the quantification.

The proposal unit 24 proposes the necessary analytical method by sending the analytical method selected by the processing unit 22 to the user terminal 12.

Next, main configurations of electrical systems of the plural user terminals 12 and the cloud server 14 in the information processing system 10 pertaining to the present embodiment will be described.

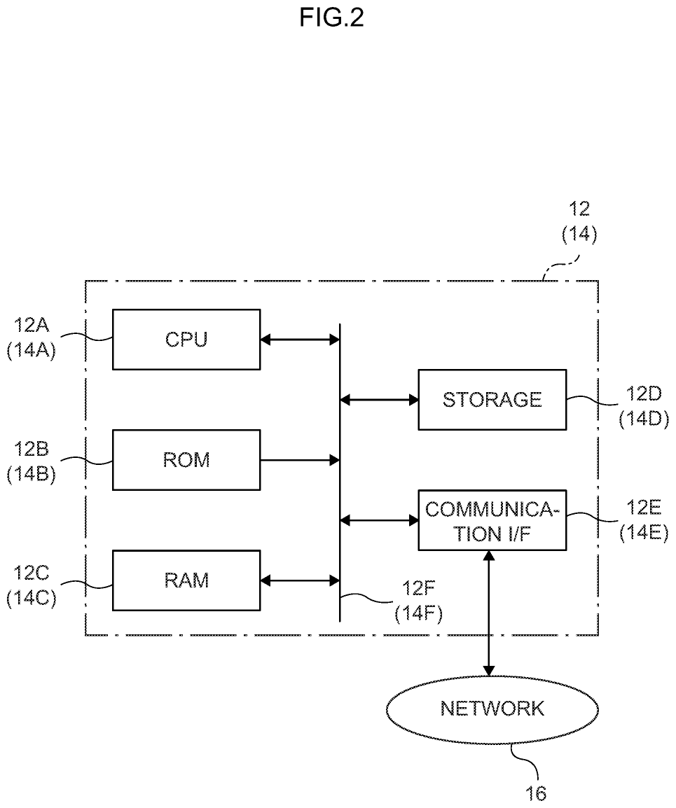

FIG. 2 is a block diagram showing the main configurations of the electrical systems of the user terminal 12 and the cloud server 14 in the information processing system 10 pertaining to the present embodiment. It will be noted that the user terminal 12 and the cloud server 14 basically have a common computer configuration, so here the user terminal 12 will be representatively described.

The user terminal 12, as shown in FIG. 2, includes a central processing unit (CPU) 12A, a read-only memory (ROM) 12B, a random-access memory (RAM) 12C, a storage 12D, and a communication interface (I/F) unit 12E.

The CPU 12A, which is an example of a hardware processor, controls the operations of the entire device by executing various types of programs. In the ROM 12B, various types of control programs and various types of parameters are prestored. The RAM 12C is used as a work area when the CPU 12A executes the various types of programs. The storage 12D is configured by various types of storage such as a hard disk drive (HDD), a solid-state drive (SSD), and flash memory and stores various types of data and application programs. The ROM 12B, the RAM 12C, and the storage 12D correspond to a memory and a non-transitory computer-readable recording medium. The communication interface unit 12E is connectable to the network 16, which is a LAN, a WAN, or the internet, for example, and sends various types of data to and receives various types of data from other devices connected to the network 16. The above parts of the user terminal 12 are electrically connected to each other by a system bus 12F.

Because of the above configurations, the user terminal 12, by means of the CPU 12A, executes control of access to the ROM 12B, the RAM 12C, and the storage 12D and the transmission and reception of communication data via the communication interface unit 12E. It will be noted that the user terminal 12 also includes an operation unit, comprising a keyboard, a mouse, and a touch panel, and a display unit that displays various types of information.

Furthermore, in the cloud server 14, the functions of the aforementioned acquisition unit 20, processing unit 22, proposal unit 24, and database 26 are realized by a CPU 14A loading and executing an information processing program stored in a ROM 14B or a storage 14D.

Next, the process, performed by the processing unit 22 of the cloud server 14, to quantify the measurement data and select a necessary analytical method from among the plural analytical methods using the results of the quantification will be described in detail.

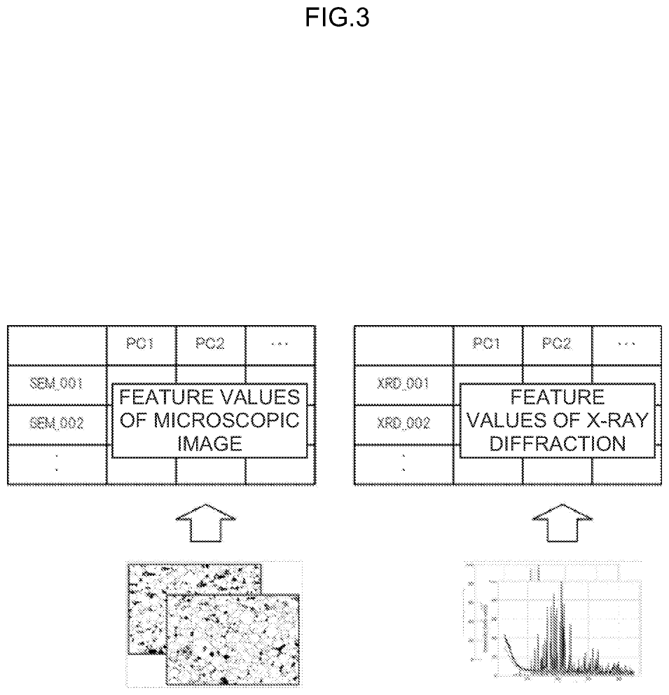

The processing unit 22 quantifies the measurement data for each of the analytical methods using a predetermined statistical method. In the present embodiment, the processing unit 22 uses, as the statistical method, principal component analysis, which is a dimensionality reduction method, and finds features by performing a principal component analysis on the measurement data for each of the analytical methods. That is, by performing a principal component analysis on the measurement data of the plural analytical methods, the processing unit 22 calculates, as features, plural principal components (PC1, PC2, . . . ) of the analysis results. For example, as shown in FIG. 3, the processing unit 22 performs a principal component analysis as an example of the statistical method on microscopic images and finds the analysis results as features of the microscopic images. Furthermore, the processing unit 22 performs a principal component analysis as an example of the statistical method on X-ray diffractions and finds plural principal components (PC1, PC2, . . . ) of the analysis results as features. FIG. 3 is a drawing showing an example where features are found by performing a principal component analysis on microscopic images and X-ray diffractions.

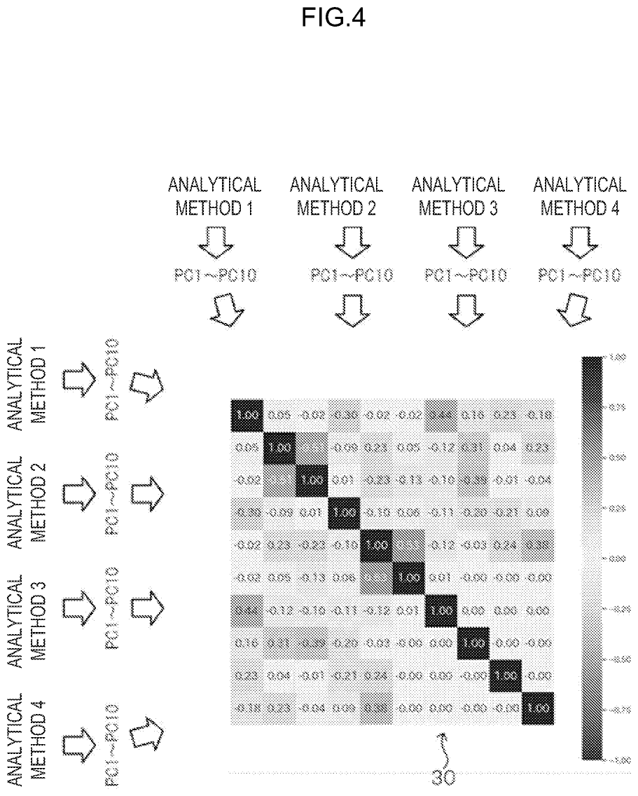

Furthermore, the processing unit 22 calculates, as values of the quantification, correlation values of the features for each of the principal components of each of the analytical methods and creates a heatmap in which magnitudes of numerical data in a matrix are visualized in color. For example, as shown in FIG. 4, the processing unit 22 performs a principal component analysis in regard to each of analytical methods 1 to 4 to thereby arrange first to tenth components (PC1 to PC10) in a 40×40 matrix and finds the correlation values for each of the principal components to create a heatmap 30. It will be noted that FIG. 4 is a drawing for describing the heatmap 30 created by the processing unit 22.

Furthermore, the processing unit 22 determines, from the correlation values of the features for each of the principal components of each of the analytical methods, methods having a high correlation (e.g., methods having a correlation equal to or greater than a predetermined threshold) to be a redundancy of information and selects the necessary analytical method by excluding one that is redundant. That is, a high correlation can describe the information quantity of the principal components of one analytical method and the information quantity of the principal components of another analytical method, so the necessary analytical method can be selected by extracting just the principal components of one analytical method.

The proposal unit 24 sends to the user terminal 12 the analytical method selected by the processing unit 22 and displays the selection result on the user terminal 12 to thereby propose to the user the necessary analytical method from among the plural analytical methods. Because of this, it becomes possible to propose an appropriate analytical method from among the plural analytical methods.

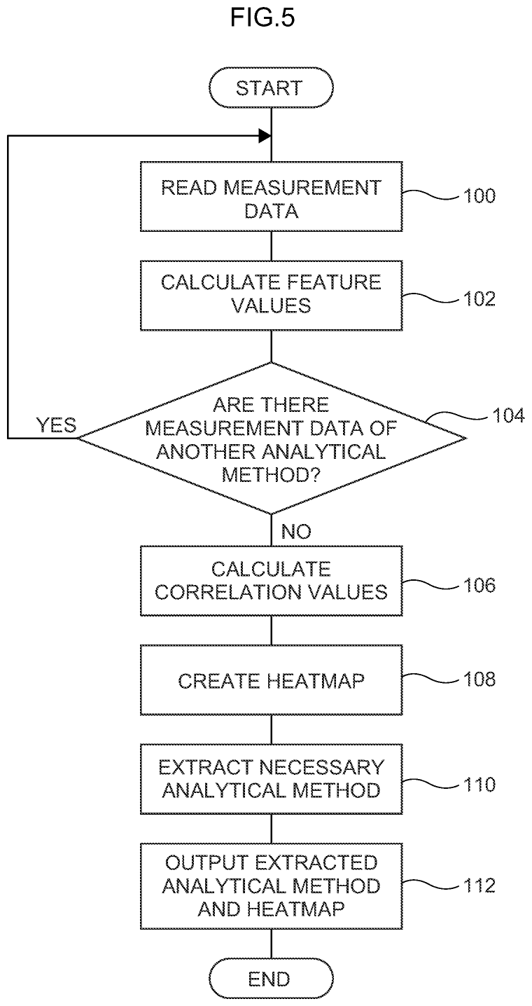

Next, specific processes performed by the cloud server 14 of the information processing system 10 pertaining to the present embodiment configured as described above will be described. FIG. 5 is a flowchart showing an example of a flow of processes performed by the cloud server 14 of the information processing system 10 pertaining to the present embodiment. It will be noted that the processes of FIG. 5 start when, for example, the measurement data have been uploaded from the user terminal 12 to the cloud server 14 and the cloud server 14 has been instructed to propose an analytical method.

In step 100 the CPU 14A acquires the measurement data, and then the CPU 14A moves to step 102. That is, the processing unit 22 reads the measurement data that have been acquired by the acquisition unit 20 from the user terminal 12 and are stored in the database 26.

In step 102 the CPU 14A calculates the features, and then the CPU 14A moves to step 104. That is, the processing unit 22 performs a principal component analysis on the measurement data of the plural analytical methods to thereby calculate, as the features, the plural principal components of the analysis results.

In step 104 the CPU 14A determines whether or not there are measurement results of other analytical methods. When the determination is YES the CPU 14A returns to step 100 and repeats the aforementioned processes, and when the determination is NO the CPU 14A moves to step 106.

In step 106 the CPU 14A calculates the correlation values for each of the calculated features, and then the CPU 14A moves to step 108. That is, the processing unit 22 calculates, as values of the quantification, the correlation values of the features for each of the principal components of each of the analytical methods.

In step 108 the CPU 14A creates the heatmap 30, and then the CPU 14A moves to step 110. That is, the processing unit 22 arranges the correlation values in a matrix as features for each of the analytical methods it has calculated and creates the heatmap 30 in which the magnitudes of the numerical values of the correlation values are visualized in color.

In step 110 the CPU 14A extracts the necessary analytical method based on the correlation values, and then the CPU 14A moves to step 112. That is, the processing unit 22 determines, from the correlation values of the features for each of the principal components of each of the analytical methods, methods having a high correlation (e.g., methods having a correlation equal to or greater than a predetermined threshold) to be a redundancy of information and selects the necessary analytical method by excluding one that is redundant.

In step 112 the CPU 14A outputs the extracted analytical method and the created heatmap 30, and then the CPU 14A ends the series of processes. That is, the proposal unit 24 sends the analytical method selected by the processing unit 22 to the user terminal 12 and displays the selection result on the display of the user terminal 12 to thereby propose to the user the necessary analytical method from among the plural analytical methods. Because of this, it becomes possible to propose an appropriate analytical method from among the plural analytical methods. The display may be a liquid crystal display or an organic electroluminescent (organic EL) diode display.

### Second Embodiment

Next, an information processing system pertaining to a second embodiment will be described. It will be noted that the configurations themselves are identical to those in the first embodiment, so detailed description will be omitted and just differences will be described.

In the above embodiment the processing unit 22 found the correlation values for each of the principal components of the analytical methods and created the heatmap 30, but in the present embodiment the processing unit 22 further finds correlation values with objective variables such as a performance value of a measurement object and creates the heatmap 30.

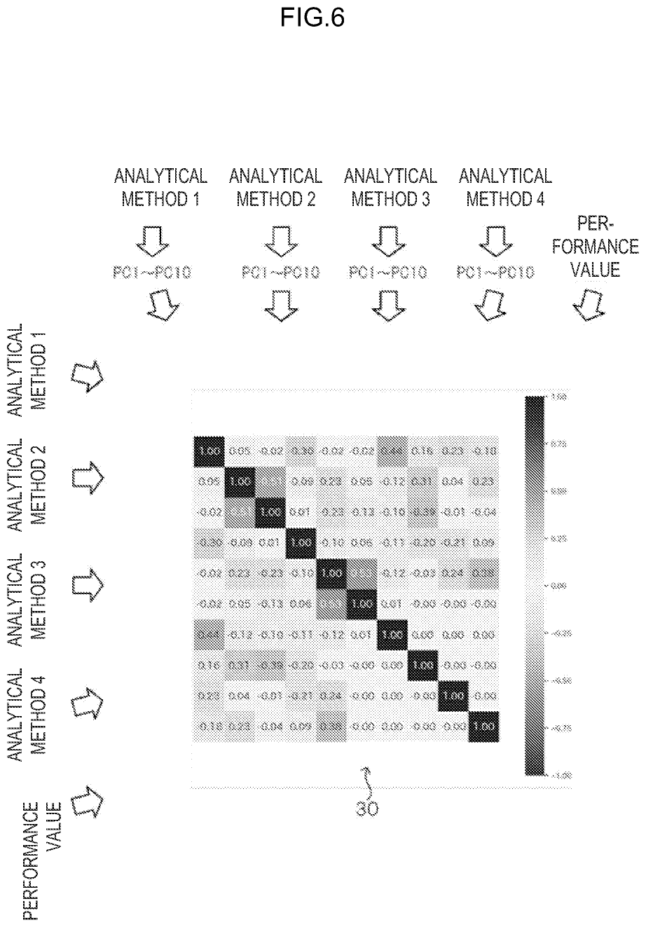

For example, as shown in FIG. 6, the processing unit 22 arranges, in a 41×41 matrix, first to tenth principal components (PC1 to PC10) of a principal component analysis of analytical methods 1 to 4 and a performance value, finds the correlation values of each, and creates the heatmap 30. It will be noted that FIG. 6 is a drawing for describing the heatmap 30 including the performance value.

Additionally, in the present embodiment, the processing unit 22 selects the analytical method with the highest correlation to the performance value and proposes it as an appropriate analytical method to the user. For example, an optimum analytical method can be proposed by selecting the analytical method with the highest correlation.

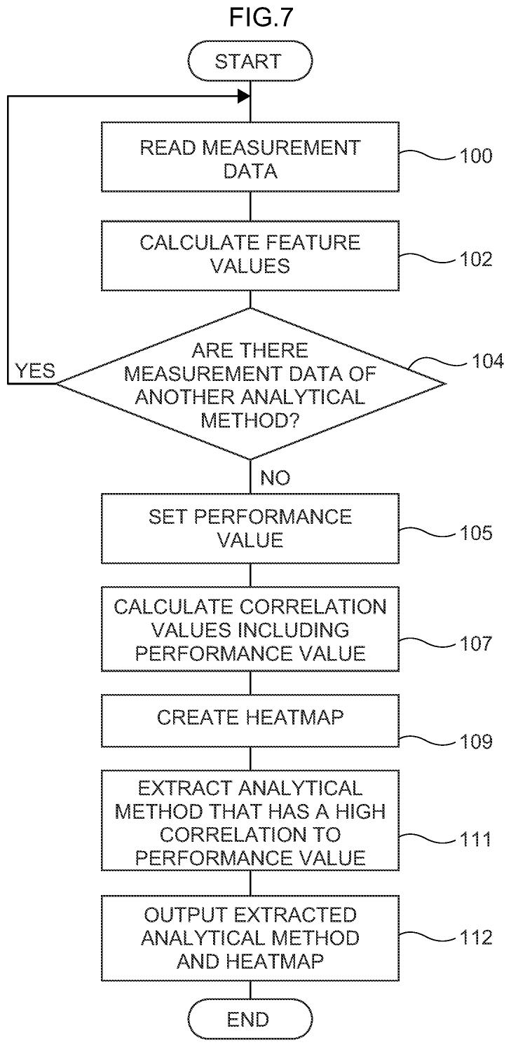

Next, details about the processes performed by the cloud server 14 of the information processing system 10 pertaining to the present embodiment will be described. FIG. 7 is a flowchart showing an example of a flow of the processes performed by the cloud server 14 of the information processing system 10 pertaining to the present embodiment. It will be noted that the processes of FIG. 7 start when, for example, the measurement data have been uploaded from the user terminal 12 to the cloud server 14 and the cloud server 14 has been instructed to propose an analytical method. Furthermore, processes identical to those in FIG. 5 will be assigned identical reference signs and described.

In step 100 the CPU 14A acquires the measurement data, and then the CPU 14A moves to step 102. That is, the processing unit 22 reads the measurement data that have been acquired by the acquisition unit 20 from the user terminal 12 and are stored in the database 26.

In step 102 the CPU 14A calculates the features, and then the CPU 14A moves to step 104. That is, the processing unit 22 performs a principal component analysis on the measurement data of the plural analytical methods to thereby calculate, as the features, the plural principal components of the analysis results.

In step 104 the CPU 14A determines whether or not there are measurement results of another analytical method. When the determination is YES the CPU 14A returns to step 100 and repeats the aforementioned processes, and when the determination is NO the CPU 14A moves to step 105.

In step 105 the CPU 14A sets a performance value, and then the CPU 14A moves to step 107. For example, the CPU 14A reads and sets a performance value prestored in the database 26.

In step 107 the CPU 14A calculates the correlation values including the performance value, and then the CPU 14A moves to step 109. That is, the processing unit 22 calculates, as values of the quantification, correlation values between the features of each of the analytical methods and the performance value.

In step 109 the CPU 14A creates the heatmap 30 including the performance value, and then the CPU 14A moves to step 111. That is, the processing unit 22 arranges in a matrix the correlation values between the features of each analytical method and the performance value and creates the heatmap 30 in which the magnitudes of the numerical values of the correlation values are visualized in color.

In step 111 the CPU 14A extracts the analytical method that has a high correlation to the performance value, and then the CPU 14A moves to step 112. For example, the CPU 14A may extract the analytical method equal to or greater than a predetermined correlation value or may extract the analytical method with the highest correlation.

In step 112 the CPU 14A outputs the extracted analytical method and the created heatmap 30, and then the CPU 14A ends the series of processes. That is, the proposal unit 24 sends the analytical method selected by the processing unit 22 to the user terminal 12 and displays the selection result on the user terminal 12 to thereby propose to the user the necessary analytical method from among the plural analytical methods. Because of this, it becomes possible to propose an appropriate analytical method from among the plural analytical methods. Furthermore, when the CPU 14A has extracted the analytical method with the highest correlation in step 111, it becomes possible to propose an optimum analytical method.

It will be noted that although in the above embodiments the CPU 14A quantified the measurement data for each of the analytical methods by performing a principal component analysis, the CPU 14A may quantify the measurement data using another statistical method. For example, the CPU 14A may quantify the measurement data using a statistical method of another dimensionality reduction method such as PPCA, kernel PCA, ICA, LSA, LDA, UMAP, t-SNE, or VAE.

Furthermore, although in the above embodiments the cloud server 14 was provided with the database 26 and the measurement data were stored in the database 26 of the cloud server 14, the database 26 is not limited to this. For example, the database 26 may be provided on a different server.

Furthermore, the processes performed by the cloud server 14 in each of the above embodiments were described as software processes performed by a CPU executing a program, but the processes are not limited to this. For example, a graphics processing unit (GPU) may be used instead of, or together with, the CPU. Furthermore, for example, the processes may be processes performed by hardware such as an application-specific integrated circuit (ASIC) or a field-programmable gate array (FPGA). Alternatively, the processes may be processes combining software and hardware. Furthermore, when the processes are software processes, the program may be stored in various types of non-transitory computer-readable storage media and circulated.

Furthermore, the present disclosure is not limited to that which is described above and may, in addition to what is described above, be modified in various ways and implemented without departing from the spirit thereof.

The present disclosure has been made in consideration of the above circumstances, and it is an object thereof to provide an information processing device that can propose an appropriate analytical method from among plural analytical methods, an information processing method, and a non-transitory computer-readable recording medium in which an information processing program is recorded.

A first aspect of the present disclosure is an information processing device, that includes: a memory; and a processor coupled to the memory, the processor being configured to: acquire, from a plurality of user terminals, measurement data measured by a plurality of analytical method; quantify the acquired measurement data using a predetermined statistical method; and display, on a display of at least one user terminal of the plurality of user terminals, a necessary analytical method among the plurality of analytical method based on results of the quantification.

According to the first aspect, measurement data measured by plural analytical methods are acquired.

Furthermore, the acquired measurement data are quantified using a predetermined statistical method.

Additionally, a necessary analytical method is proposed from among the plural analytical methods using the processing results. Because of this, it becomes possible to propose an appropriate analytical method from among plural analytical methods.

A second aspect of the present disclosure is the information processing device of the first aspect, wherein the processor is configured to: obtain, by using a principal component analysis as the statistical method, feature values for each of the plurality of analytical method; and calculate, as values of the quantification, correlation values of the feature values for each of the plurality of analytical method.

According to the second aspect, it becomes possible to exclude unnecessary analytical methods based on the correlation values.

A third aspect of the present disclosure is the information processing device of the second aspect, wherein the processor is configured to, by using the correlation values, create a heatmap in which magnitudes of numerical data in a matrix are visualized in color.

According to the third aspect, the correlations of the features for each of the analytical methods can be visually checked.

A fourth aspect of the present disclosure is the information processing device of the second aspect, wherein the processor is configured to further calculate correlation values between the feature values and a performance value of a measurement object.

According to the fourth aspect, it becomes possible to propose an optimum analytical method.

A fifth aspect of the present disclosure is an information processing method, that comprises, by a processor: acquiring, from a plurality of user terminals, measurement data measured by a plurality of analytical method; quantifying the measurement data using a predetermined statistical method; and displaying, on a display of at least one user terminal of the plurality of user terminals, a necessary analytical method among the plurality of analytical method based on results of the quantification.

According to the fifth aspect, an information processing method that can propose an appropriate analytical method from among plural analytical methods can be provided.

A sixth aspect of the present disclosure is a non-transitory computer-readable storage medium storing an information processing program executable by a computer to perform processing, the processing comprising: acquiring, from a plurality of user terminals, measurement data measured by a plurality of analytical method; quantifying the measurement data using a predetermined statistical method; and displaying, on a display of at least one user terminal of the plurality of user terminals, a necessary analytical method among the plurality of analytical method based on results of the quantification.

According to the sixth aspect, an information processing program that can propose an appropriate analytical method from among plural analytical methods can be provided.

As described above, according to the present disclosure, there can be provided an information processing device that can propose an appropriate analytical method from among plural analytical methods, an information processing method, and a non-transitory computer-readable recording medium in which an information processing program is recorded.

What is claimed is:

1. An information processing device, comprising:
a memory; and
a processor coupled to the memory, the processor being configured to:
acquire, from a plurality of user terminals, measurement data measured by a plurality of analytical method;
quantify the acquired measurement data using a predetermined statistical method; and
display, on a display of at least one user terminal of the plurality of user terminals, a necessary analytical method among the plurality of analytical method based on results of the quantification.

2. The information processing device of claim 1, wherein the processor is configured to:
obtain, by using a principal component analysis as the statistical method, feature values for each of the plurality of analytical method; and
calculate, as values of the quantification, correlation values of the feature values for each of the plurality of analytical method.

3. The information processing device of claim 2, wherein the processor is configured to, by using the correlation values, create a heatmap in which magnitudes of numerical data in a matrix are visualized in color.

4. The information processing device of claim 2, wherein the processor is configured to further calculate correlation values between the feature values and a performance value of a measurement object.

5. An information processing method, comprising:
by a processor,
acquiring, from a plurality of user terminals, measurement data measured by a plurality of analytical method;
quantifying the measurement data using a predetermined statistical method; and
displaying, on a display of at least one user terminal of the plurality of user terminals, a necessary analytical method among the plurality of analytical method based on results of the quantification.

6. A non-transitory computer-readable storage medium storing an information processing program executable by a computer to perform processing, the processing comprising:
acquiring, from a plurality of user terminals, measurement data measured by a plurality of analytical method;
quantifying the measurement data using a predetermined statistical method; and
displaying, on a display of at least one user terminal of the plurality of user terminals, a necessary analytical method among the plurality of analytical method based on results of the quantification.
